(19) United States
(12) Patent Application Publication
(10) Pub. No.: US 2022/0236721 A1
(43) Pub. Date: Jul. 28, 2022

(54) PARAMETER IDENTIFICATION DEVICE, PARAMETER IDENTIFICATION METHOD, AND COMPUTER READABLE STORAGE MEDIUM

(71) Applicant: Mitsubishi Electric Corporation, Tokyo (JP)

(72) Inventor: Masaoki IWASE, Tokyo (JP)

(73) Assignee: Mitsubishi Electric Corporation, Tokyo (JP)

(21) Appl. No.: 17/613,081

(22) PCT Filed: Jul. 19, 2019
(86) PCT No.: PCT/JP2019/028483

§ 371 Date: Nov. 22, 2021

(51) Int. Cl. G05B 19/418

(52) U.S. Cl. CPC G05B 19/41865; G05B 19/4188; G05B 19/4183

(57) ABSTRACT

A parameter identification device that identifies a parameter of a target system includes: a first calculation unit that calculates an extended state quantity in a second time step that is a next time step of a first time step, using a first equation, a first quantity in the first time step, and an input value to the system in the first time step; a second calculation unit that calculates an output of the system in the first time step, using the first equation, a second equation, the extended state quantity in the first time step, and the input value in the first time step; and an estimation unit that estimates the extended state quantity, using an input value to and an output value from the system acquired in each time step, the first calculation unit, and the second calculation unit.

### FIELD

The present invention relates to a parameter identification device, a parameter identification method, and a computer program for identifying a parameter of a target system.

### BACKGROUND

In parameter identification, there is a technique of simultaneously estimating a state quantity and a parameter by using an extended state quantity obtained by including a parameter to be identified in a state quantity, and applying a state estimation technique such as a Kalman filter or a particle filter to an extended state space model defined using the extended state quantity.

For example, Patent Literature 1 discloses a technique of identifying a parameter of a target system using an extended state quantity. Patent Literature 1 uses, as inputs, a discrete extended equation of state expressing an extended state quantity in an optional step using an extended state quantity in a step immediately before the optional step, and an extended observation equation expressing an output of a system in the optional step using the extended state quantity in the optional step.

The introduction of the extended state quantity makes it possible to reduce the number of state quantity data measurement points, and thus the parameter can be identified even when not all the state quantities can be measured.

### CITATION LIST

### Patent Literature

Patent Literature 1: Japanese Patent Application Laid-open No. 2017-083922

### SUMMARY

### Technical Problem

However, according to the above-described conventional technique, a first-order differential value of the state quantity cannot be calculated. Accordingly, there is a problem in that the technique cannot be applied in a case where the first-order differential value of the state quantity is used when identifying a parameter. For example, in data measurement in a mechanical system, an acceleration sensor is often used. In a case where a parameter is identified using measurement data of the acceleration sensor, when the measurement data of the acceleration sensor is used as a part or all of elements of an output of a system, an observation equation expressing the output of the system is described using a state quantity at a certain time and a first-order differential value of the state quantity at the certain time. Therefore, in the case where a parameter is identified using measurement data of the acceleration sensor, the first-order differential value of the state quantity is used.

The present invention has been made in view of the above, and an object thereof is to obtain a parameter identification device applicable even when a first-order differential value of a state quantity is used.

### Solution to Problem

To solve the above problem and achieve an object, the parameter identification device according to the present invention that identifies a parameter of a target system, includes: a first storage unit to store a first equation that is a continuous equation, which expresses a first-order differential value of a first quantity including a state quantity of the system using an input value to the system and the first quantity; a second storage unit to store a second equation, which expresses an output of the system using the first-order differential value and an extended state quantity that includes the state quantity and the parameter; a first calculation unit to calculate the extended state quantity in a second time step that is a next time step of a first time step, using the first equation, a first quantity in the first time step, and an input value to the system in the first time step; a second calculation unit to calculate an output of the system in the first time step, using the first equation, the second equation, the extended state quantity in the first time step, and the input value in the first time step; and an estimation unit to estimate the extended state quantity, using an input value to the system acquired in each time step, an output value from the system acquired in each time step, the first calculation unit, and the second calculation unit.

### Advantageous Effects of Invention

The present invention achieves an effect that it is possible to obtain a parameter identification device applicable even when a first-order differential value of a state quantity is used.

### BRIEF DESCRIPTION OF DRAWINGS

FIG. 1 is a diagram illustrating a functional configuration of a parameter identification device according to a first embodiment of the present invention.

FIG. 2 is a diagram for explaining an internal process of a first calculation unit illustrated in FIG. 1.

FIG. 3 is a diagram for explaining an internal process of a second calculation unit of FIG. 1.

FIG. 4 is a flowchart for explaining a process of identifying a parameter by the parameter identification device illustrated in FIG. 1.

FIG. 5 is a diagram illustrating a functional configuration of a parameter identification device according to a second embodiment of the present invention.

FIG. 6 is a diagram for explaining an internal process of a first calculation unit illustrated in FIG. 5.

FIG. 7 is a diagram for explaining an internal process of a second calculation unit illustrated in FIG. 5.

FIG. 8 is a diagram illustrating a functional configuration of a parameter identification device according to a third embodiment of the present invention.

FIG. 9 is a diagram illustrating dedicated hardware for realizing functions of the parameter identification devices according to the first to third embodiments of the present invention.

FIG. 10 is a diagram illustrating a configuration of a control circuit for realizing the functions of the parameter identification devices according to the first to third embodiments of the present invention.

FIG. 11 is a diagram illustrating an example application of the parameter identification devices according to the first to third embodiments of the present invention.

### DESCRIPTION OF EMBODIMENTS

Hereinafter, a parameter identification device, a parameter identification method, and a computer program according to each embodiment of the present invention will be described in detail with reference to the drawings. The present invention is not limited to the embodiments.

### First Embodiment

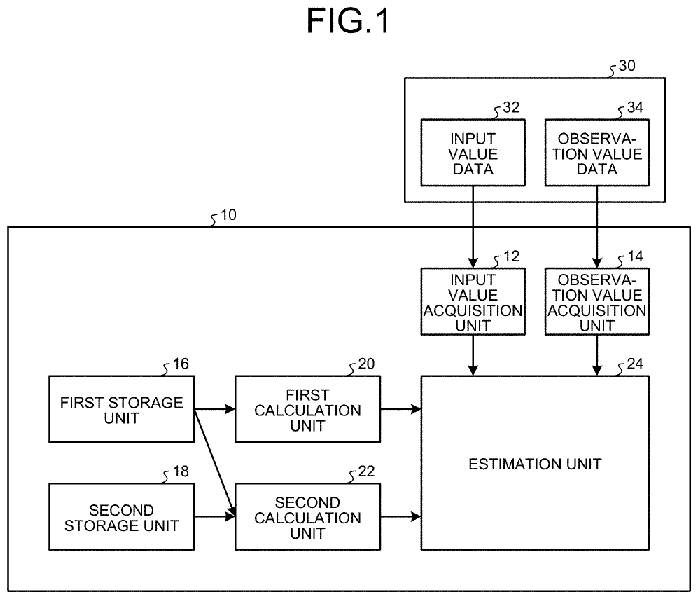

FIG. 1 is a diagram illustrating a functional configuration of a parameter identification device 10 according to a first embodiment of the present invention. The parameter identification device 10 identifies a parameter θ of a target system. The parameter identification device 10 has a function of identifying the parameter θ by simultaneously estimating the parameter θ and a state quantity x using an extended state quantity z including the parameter θ to be identified and the state quantity x.

The parameter identification device 10 includes an input value acquisition unit 12, an observation value acquisition unit 14, a first storage unit 16, a second storage unit 18, a first calculation unit 20, a second calculation unit 22, and an estimation unit 24.

The parameter identification device 10 is used offline. In an external storage medium 30, input value data 32 and observation value data 34 from a predetermined period are stored in advance. The input value data 32 is time-series data indicating an input value to the target system, and the observation value data 34 is time-series data indicating an observation value of an output from the target system. The predetermined period is a period in which time t is between 0 and T.

The input value acquisition unit 12 acquires an input value u from the input value data 32 stored in the external storage medium 30 in each time step, that is, at regular intervals. The input value acquisition unit 12 outputs the acquired input value u to the estimation unit 24. Hereinafter, the input value u in a k-th step is denoted by uₖ. The same applies to other values, and in a case where a step number is added using a subscript to a reference sign indicating a specific value, the value indicated thereby is a value in the step. Here, in a case where a period of a time step is denoted by Ts, k takes a value from 0 to T/Ts.

The observation value acquisition unit 14 acquires an observation value yₖ from the observation value data 34 stored in the external storage medium 30 in each time step, that is, at regular intervals. The observation value acquisition unit 14 outputs the acquired observation value yₖ to the estimation unit 24.

The first storage unit 16 stores a first equation which is a continuous equation of state expressing a state at an optional time. The first equation is a continuous equation of state expressing a first-order differential value of a first quantity that includes the state quantity of the system, using the input value u to the system and the first quantity. In the present embodiment, the first quantity is the extended state quantity z including the state quantity x and the parameter θ.

First, the continuous equation of state of the target system is expressed by using the following formula (1).

[Formula 1]

xdot=f₀(x,u,θ) (1)

Here, f₀ is a known nonlinear function, x is a state quantity of the system, xdot is a first-order differential value of the state quantity, and C is a parameter of the target system. The state quantity is a vector quantity. Elements of the state quantity x of the system include variables related to position and velocity with respect to translational motion or rotational motion of the system.

A temporal change amount θdot of the parameter θ of the target system is expressed by the following formula (2).

[Formula 2]

θdot=p(t) (2)

In the present embodiment, the parameter θ takes a value that changes with time. From formula (1) and formula (2), formula (3) which is the following extended continuous equation of state is derived. In the present embodiment, the first equation is formula (3).

[Formula 3]

zdot=f(z,u) (3)

In formula (3), z is an extended state quantity, which is a vector quantity. The definition thereof is given as z=(x,θ)^{T}, and zdot is a first-order differential value obtained by time-differentiating the extended state quantity z. f is a known nonlinear function derived from formulas (1) and (2). As is clear from formula (3), the first-order differential value zdot of the extended state quantity z at a certain time can be calculated on the basis of the extended state quantity z and the input value u at the time.

The second storage unit 18 stores an extended observation equation which is a second equation expressing an observation value y which is an output of the system, using the extended state quantity z and the first-order differential value zdot of the extended state quantity z. The extended observation equation which is the second equation is expressed by the following formula (4).

[Formula 4]

y=g(z,zdot) (4)

y is an observation value of the system at a certain time. g is a known nonlinear function. As is clear from formula (4), the observation value y at a certain time is calculated on the basis of, in addition to the extended state quantity z at a certain time, the first-order differential value zdot of the extended state quantity z. It is indicated that, for example, in a case where the observation value is acceleration sensor data, the acceleration sensor data is described using position, velocity, and acceleration with respect to the translational and rotational motion of the system. The known nonlinear function g is formulated, for example, by the kinematics of the target system.

The first calculation unit 20 performs numerical discretization of the first equation stored in the first storage unit 16 on the basis of a predetermined numerical integration method to derive a third equation. The third equation expresses an extended state quantity zₖ₊₁ in a (k+1)-th step using an extended state quantity zₖ in the k-th step and the input value uₖ output by the input value acquisition unit 12. In a case where a k step is referred to as a first time step, a k+1 step can be referred to as a second time step which is a next time step of the first time step. The third equation derived by the first calculation unit 20 is expressed by the following formula (5).

[Formula 5]

zₖ₊₁=f_{d}(zₖ,uₖ) (5)

In formula (5), f_{d} is a non-finite function. For example, in a case of using the fourth-order Runge-Kutta method which is a numerical integration method, the extended state quantity zₖ₊₁ in the (k+1)-th step is calculated using the following formula (6).

$$\begin{matrix}[ Formula 6 ] & \\ {z}_{k + 1} = {z}_{k} + \frac{{T}_{s}}{6} ( {k}_{1} + 2 {k}_{2} + 2 {k}_{3} + {k}_{4} ) & ( 6 )\end{matrix}$$

Here, k₁ to k₄ in formula (6) are variables related to slopes in the fourth-order Runge-Kutta method, and are expressed by the following formulas (7) to (10) when a zero-order hold is applied to the input value u.

$$\begin{matrix}[ Formula 7 ] & \\ {k}_{1} = f ( {z}_{k} , {u}_{k} ) & ( 7 ) \\ [ Formula 8 ] & \\ {k}_{2} = f ( {z}_{k} + \frac{{T}_{s}}{2} {k}_{1} , {u}_{k} ) & ( 8 ) \\ [ Formula 9 ] & \\ {k}_{3} = f ( {z}_{k} + \frac{{T}_{s}}{2} {k}_{2} , {u}_{k} ) & ( 9 ) \\ [ Formula 10 ] & \\ {k}_{4} = f ( {z}_{k} + {T}_{s} {k}_{3} , {u}_{k + 1} ) & ( 10 )\end{matrix}$$

The above k₁ to k₄ can be calculated using formula (3) which is the first equation stored in the first storage unit 16. The first calculation unit 20 calculates the extended state quantity zₖ₊₁ in the second time step using the first equation, the extended state quantity zₖ as the first quantity in the first time step, and the input value uₖ in the first time step.

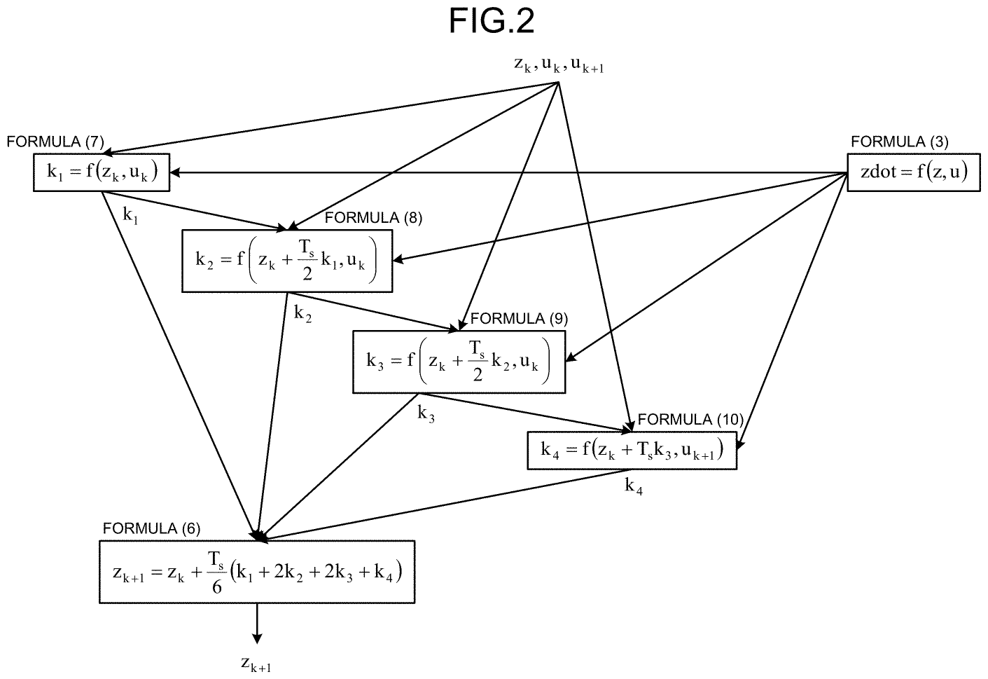

FIG. 2 is a diagram for explaining an internal process of the first calculation unit 20 illustrated in FIG. 1. The first calculation unit 20 calculates k₁ to k₄ expressed by formulas (7) to (10) using the extended state quantity zₖ, the input values uₖ and uₖ₊₁, and formula (3). The first calculation unit 20 calculates the extended state quantity zₖ₊₁ in the second time step using the calculated k₁ to k₄ and formula (6).

With the use of the first storage unit 16 and the second storage unit 18, the second calculation unit 22 calculates the observation value yₖ which is an output of the system in the k-th step, using the extended state quantity zₖ in the k-th step and the input value uₖ output by the input value acquisition unit 12. The second calculation unit 22 calculates the observation value yₖ by inputting the extended state quantity zₖ and the input value uₖ to a fourth equation that is obtained using the first equation and the second equation. The fourth equation is expressed by the following formula (11).

[Formula 11]

yₖ=g_{d}(zₖ,uₖ) (11)

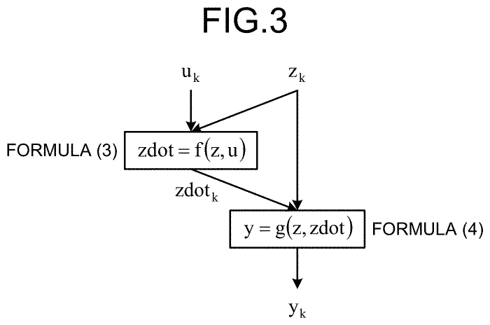

FIG. 3 is a diagram for explaining an internal process of the second calculation unit 22 of FIG. 1. The second calculation unit 22 calculates a first-order differential value zdotₖ of the extended state quantity zₖ in the k-th step on the basis of the extended state quantity zₖ in the k-th step, the input value uₖ output by the input value acquisition unit 12, and formula (3) which is the first equation stored in the first storage unit 16. The second calculation unit 22 calculates the observation value yₖ in the k-th step using the calculated first-order differential value zdotₖ, the extended state quantity zₖ, and formula (4) which is the second equation.

In a case where a time differential value of a state quantity cannot be calculated using a continuous equation of state because the parameter itself in the continuous equation of state is an estimation target and is an unknown value in the simultaneous estimation of the state quantity and the parameter to which a state estimation technique by the acceleration sensor data is applied, the above operation employs, as the parameter θ, values which are estimated sequentially, thereby making it possible to calculate the time differential value of the state quantity.

With the use of an optional state estimation method, the estimation unit 24 estimates the extended state quantity z on the basis of the input value uₖ output by the input value acquisition unit 12, the observation value yₖ output by the observation value acquisition unit 14, formula (5) which is the third equation obtained from the first calculation unit 20, and formula (11) which is the fourth equation obtained from the second calculation unit 22.

The state estimation method used by the estimation unit 24 is not limited, and may be another state estimation method such as a particle filter, an extended Kalman filter, or an uncented Kalman filter.

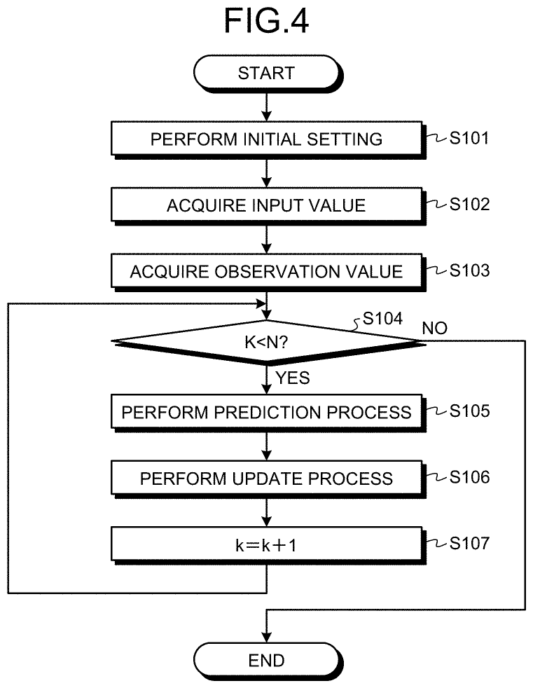

FIG. 4 is a flowchart for explaining a process of identifying the parameter θ by the parameter identification device 10 illustrated in FIG. 1. Here, an example will be described in which the extended Kalman filter is used. In the following description, reference signs with hats are indicated with \hat{ } after the reference signs. Similarly, reference signs with bars are indicated with ⁻ after the reference signs. The reference signs with hats denote estimation values of values indicated by the reference signs, and the reference signs with bars denote prediction values of values indicated by the reference signs.

The estimation unit 24 performs initial setting for setting an estimation value zₖ\hat{ } of the extended state quantity zₖ at k=0, an estimation value Pₖ\hat{ } of a covariance matrix of the extended state quantity, a system noise matrix value Q, and an observation noise matrix value R (step S101).

In a case of using a particulate filter such as a particle filter or an uncented Kalman filter, it is only required to perform general initial setting of a value corresponding to each filter.

The estimation unit 24 acquires the input value uₖ acquired in each time step by the input value acquisition unit 12 from the input value data 32 stored in the external storage medium 30 (step S102). The estimation unit 24 acquires the observation value yₖ acquired in each time step by the observation value acquisition unit 14 from the observation value data 34 stored in the external storage medium 30 (step S103). Note that the processes indicated in step S101 to step S103 can be executed in any order.

Subsequently, the estimation unit 24 determines whether k which is a current time step is smaller than a predetermined number N (step S104).

If k is smaller than N (step S104: Yes), the estimation unit 24 performs a prediction process (step S105). Specifically, as expressed by the following formula (12), the estimation unit 24 substitutes the estimation value zₖ\hat{ } of the extended state quantity zₖ and the input value uₖ in the step into formula (5) which is the third equation obtained from the first calculation unit 20 to predict the extended state quantity zₖ₊₁ in the next step k+1. This extended state quantity prediction value is referred to as zₖ₊₁⁻.

[Formula 12]

zₖ₊₁⁻=f_{d}(\hat{z}ₖ,uₖ) (12)

Subsequently, the estimation unit 24 calculates a Jacobian matrix Aₖ of f_{d} defined by the following formula (13).

$$\begin{matrix}[ Formula 13 ] & \\ {{A}_{k} = \frac{\partial {f}_{d} ( {z}_{k} , {u}_{k} )}{\partial {z}_{k}} \vert}_{{z}_{k} = {\hat{z}}_{k} , {u}_{k}} & ( 13 )\end{matrix}$$

In the calculation of the Jacobian matrix Aₖ, for example, the estimation unit 24 can use numerical differentiation of formula (5) which is the third equation. On the basis of the Jacobian matrix Aₖ obtained by formula (13), the estimation value Pₖ\hat{ } of the covariance matrix in the step, and the system noise matrix value Q set in advance, a covariance matrix Pₖ₊₁ in the next step k+1 is predicted as expressed by the following formula (14). The predicted covariance matrix is referred to as Pₖ₊₁⁻.

[Formula 14]

Pₖ₊₁⁻=Aₖ\hat{P}ₖAₖ^{T}+Q (14)

Note that, regarding the course of the calculation using formula (5) in this step, as described above, the extended state quantity zₖ₊₁ in the (k+1)-th step is calculated with the use of the first storage unit 16 inside the first calculation unit 20 by the predetermined numerical integration method on the basis of the extended state quantity zₖ in the k-th step and the input value uₖ.

The estimation unit 24 performs an update process after performing the prediction process (step S106). First, the estimation unit 24 calculates a Jacobian matrix Cₖ₊₁ of g_{d} defined by the following formula (15).

$$\begin{matrix}[ Formula 15 ] & \\ {{C}_{k + 1} = \frac{\partial {g}_{d} ( {z}_{k} , {u}_{k} )}{\partial {z}_{k}} \vert}_{{z}_{k} = {z}_{k + {1}^{-}} , {u}_{k + 1}} & ( 15 )\end{matrix}$$

The Jacobian matrix Cₖ₊₁ can be calculated, for example, by numerical differentiation of a modified extended observation equation expressed by formula (11) which is the fourth equation. Subsequently, a Kalman gain Gₖ₊₁ is calculated using the following formula (16) on the basis of the covariance matrix prediction value Pₖ₊₁⁻ obtained in step S105, the Jacobian matrix Cₖ₊₁ obtained by formula (15), and the observation noise matrix value R set in advance.

[Formula 16]

Gₖ₊₁=Pₖ₊₁⁻Cₖ₊₁^{T}(Cₖ₊₁\hat{P}ₖ₊₁Cₖ₊₁^{T}+R)⁻¹ (16)

First, as expressed by the following formula (17), the estimation unit 24 calculates an estimation value zₖ₊₁\hat{ } of the extended state quantity in step k+1 on the basis of a predicted extended state quantity zₖ₊₁⁻, the Kalman gain Gₖ₊₁, an observation value yₖ₊₁, the input value uₖ₊₁, and formula (11) which is the fourth equation.

[Formula 17]

\hat{z}ₖ₊₁=zₖ₊₁⁻+Gₖ₊₁{yₖ₊₁−g_{d}(zₖ₊₁⁻,uₖ₊₁)} (17)

Furthermore, as expressed by the following formula (18), the estimation unit 24 calculates an estimation value Pₖ₊₁\hat{ } of the covariance matrix in step k+1 on the basis of the Kalman gain Gₖ₊₁, the Jacobian matrix Cₖ₊₁, and the covariance matrix prediction value Pₖ₊₁.

[Formula 18]

\hat{P}ₖ₊₁={I−Gₖ₊₁Cₖ₊₁}Pₖ₊₁⁻ (18)

Note that, regarding the course of the calculation using formula (11) which is the fourth equation in this step, as described above, the observation value yₖ in the k-th step is calculated with the use of the first storage unit 16 and the second storage unit 18 inside the second calculation unit 22, on the basis of the extended state quantity zₖ in the k-th step and the input value uₖ acquired from the input value acquisition unit 12.

Upon completion of the process in step S106, the estimation unit 24 increments the value of k by 1 (k=k+1) (step S107), and repeats steps S104 to S107, thereby performing simultaneous estimation. If k becomes equal to or greater than N (step S104: No), the parameter identification device 10 ends the process.

As described above, according to the first embodiment of the present invention, the parameter identification device 10 stores the first equation which is a continuous equation expressing the first-order differential value zdot of the extended state quantity z, which is the first quantity including the state quantity of the system, using the input value u of the system and the first quantity. The parameter identification device 10 performs parameter identification using the first equation. As a result, even in a case where it is necessary to estimate the first-order differential value of the state quantity, for example, in a case where measurement data of an acceleration sensor is used, the parameter can be identified.

In a case where acceleration sensor data is converted into data regarding position or velocity by a method such as numerical integration, and the data is used as a part or all of the elements of the observation value, the observation equation becomes a general format described only by an extended state quantity at a certain time. However, in that case, it is necessary to deal with an integration error generated when the numerical integration of the acceleration sensor data is performed, and for example, the number of man-hours of filter design work for removing the error increases. On the other hand, according to the present embodiment, the filter design work for dealing with the error can be omitted.

### Second Embodiment

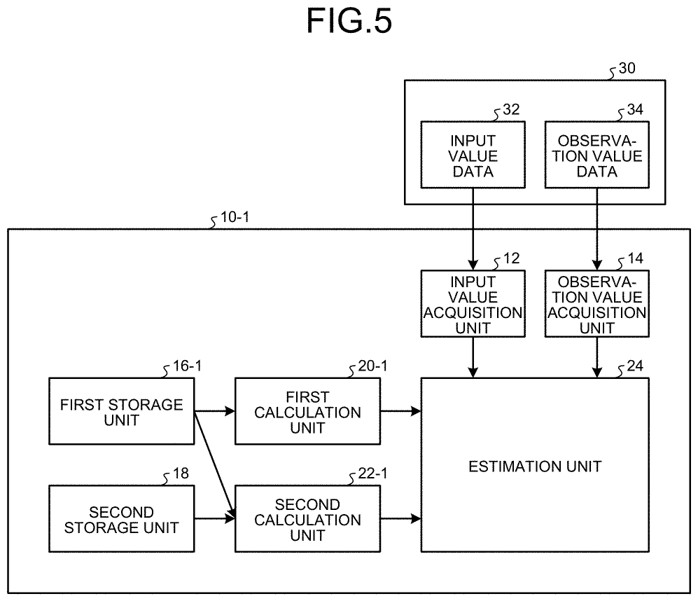

FIG. 5 is a diagram illustrating a functional configuration of a parameter identification device 10-1 according to a second embodiment of the present invention. The parameter identification device 10-1 is suitable in a case where the parameter θ of the target system does not change with time, that is, the parameter θ is time-invariant. The parameter identification device 10-1 includes a first storage unit 16-1, a first calculation unit 20-1, and a second calculation unit 22-1, respectively instead of the first storage unit 16, the first calculation unit 20, and the second calculation unit 22 of the parameter identification device 10 according to the first embodiment.

The temporal change amount θdot of the parameter θ of the target system is slow relative to a dynamic behavior of the target system, and therefore can be regarded as time-invariant in some cases. That is, it can be regarded that θdot=0 holds. In that case, the following formula (19) holds for a parameter θₖ in a certain time step k and a parameter θₖ₊₁ in step k+1.

[Formula 19]

θₖ₊₁=θₖ (19)

In the present embodiment, the first equation is a continuous equation of state expressed by the above formula (1), and the first quantity is the state quantity x. The first storage unit 16-1 stores the first equation expressed by the above formula (1).

The first calculation unit 20-1 performs numerical discretization of the first equation stored in the first storage unit 16-1 on the basis of a predetermined numerical integration method to derive the third equation. The third equation expresses the extended state quantity zₖ₊₁ in the (k+1)-th step, using the extended state quantity zₖ in the k-th step and the input value uₖ output by the input value acquisition unit 12. The third equation derived by the first calculation unit 20-1 is expressed by the above formula (5).

For example, in a case where the first calculation unit 20-1 employs the fourth-order Runge-Kutta method as the numerical integration method, a state quantity xₖ₊₁ in the (k+1)-th step is expressed by the following formula (20).

$$\begin{matrix}[ Formula 20 ] & \\ {x}_{k + 1} = {x}_{k} + \frac{{T}_{s}}{6} ( {k}_{1}^{′} + 2 {k}_{2}^{′} + 2 {k}_{3}^{′} + {k}_{4}^{′} ) & ( 20 )\end{matrix}$$

Here, k₁′ to k₄′ in formula (20) are variables related to slopes in the fourth-order Runge-Kutta method, and are expressed by the following formulas (21) to (24) when a zero-order hold is applied to the input value u.

$$\begin{matrix}[ Formula 21 ] & \\ {k}_{1}^{′} = {f}_{0} ( {x}_{k} , {u}_{k} , {θ}_{k} ) & ( 21 ) \\ [ Formula 22 ] & \\ {k}_{2}^{′} = {f}_{0} ( {x}_{k} + \frac{{T}_{s}}{2} {k}_{1}^{′} , {u}_{k} , {θ}_{k} ) & ( 22 ) \\ [ Formula 23 ] & \\ {k}_{3}^{′} = {f}_{0} ( {x}_{k} + \frac{{T}_{s}}{2} {k}_{2}^{′} , {u}_{k} , {θ}_{k} ) & ( 23 ) \\ [ Formula 24 ] & \\ {k}_{4}^{′} = {f}_{0} ( {x}_{k} + {T}_{s} {k}_{3}^{′} , {u}_{k + 1} , {θ}_{k} ) & ( 24 )\end{matrix}$$

The above k₁′ to k₄′ can be calculated using formula (1) which is the first equation stored in the first storage unit 16-1. The extended state quantity zₖ₊₁ in the (k+1)-th step can be calculated, in accordance with the definition thereof, as zₖ₊₁=(xₖ₊₁,θₖ₊₁)^{T} from the calculation results of formula (19) and formula (20).

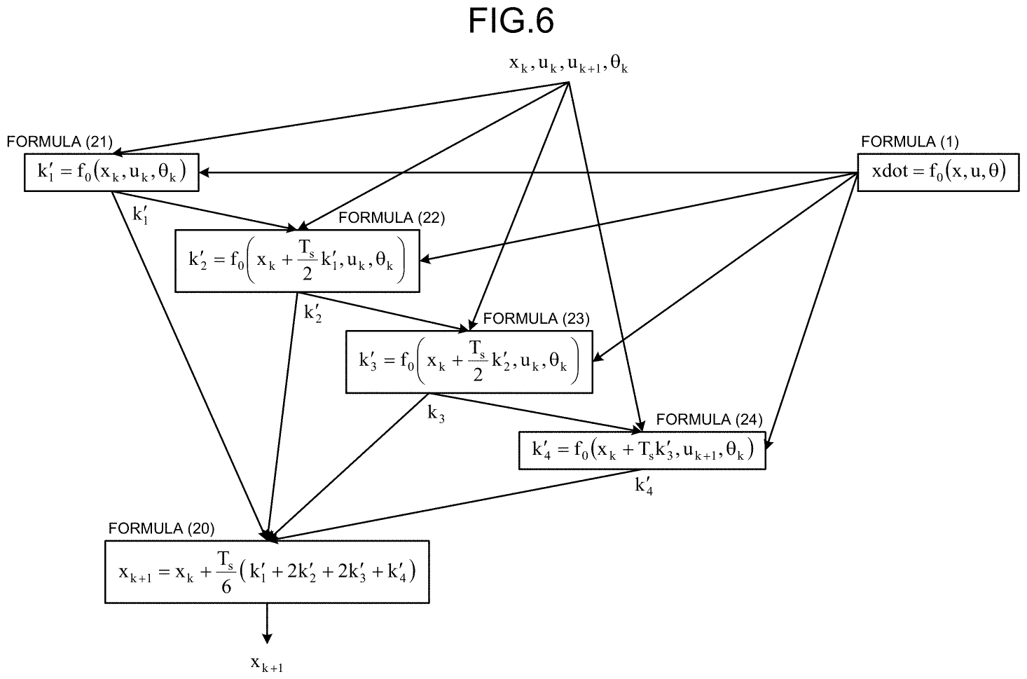

FIG. 6 is a diagram for explaining an internal process of the first calculation unit 20-1 illustrated in FIG. 5. The first calculation unit 20-1 calculates k₁′ to k₄′ expressed by formulas (21) to (24), on the basis of formula (1) which is the first equation, the state quantity xₖ, the input value uₖ, the parameter θₖ in the k-th step, and the input value uₖ₊₁ in the (k+1)-th step. The first calculation unit 20-1 calculates the state quantity xₖ+1 using k₁′ to k₄′ and formula (20).

With the use of the first storage unit 16-1 and the second storage unit 18, the second calculation unit 22-1 calculates the observation value yₖ in the k-th step on the basis of the extended state quantity zₖ in the k-th step and the input value uₖ acquired from the input value acquisition unit 12.

The second calculation unit 22-1 calculates the observation value yₖ by inputting the extended state quantity zₖ and the input value uₖ to the fourth equation obtained using the first equation and the second equation. The fourth equation is expressed by the above formula (11).

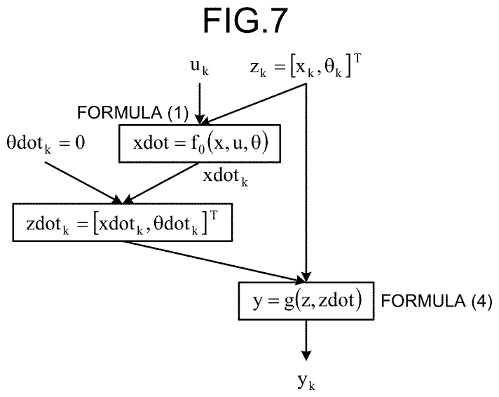

FIG. 7 is a diagram for explaining an internal process of the second calculation unit 22-1 illustrated in FIG. 5. The second calculation unit 22-1 calculates the time differential value xdotₖ of the state quantity in the k-th step, using the state quantity xₖ and the parameter θₖ included in the extended state quantity zₖ in the k-th step, the input value uₖ acquired from the input value acquisition unit 12, and formula (1) which is the first equation.

Regarding the first-order differential value zdotₖ of the extended state quantity, in accordance with the definition thereof and on the assumption that the parameter θ is time-invariant, zdotₖ=(xdotₖ,0)^{T} holds. On the basis of the extended state quantity zₖ and the first-order differential value zdotₖ of the extended state quantity in the k-th step that are calculated, the observation value yₖ in the k-th step is calculated using formula (4) which is the second equation stored in the second storage unit 18.

The parameter identification devices 10 and 10-1 execute the first equation and the second equation a plurality of times in the course of a numerical discretization process and an identification process. When comparing formula (3) which is the first equation of the first embodiment with formula (1) which is the first equation of the second embodiment, the following is revealed: formula (1) does not include the parameter θ in the state quantity, which results in an effect that a storage area and an operation amount can be reduced as compared with formula (3).

The process of identifying the parameter θ by the parameter identification device 10-1 is similar to the process of identifying the parameter θ by the parameter identification device 10.

### Third Embodiment

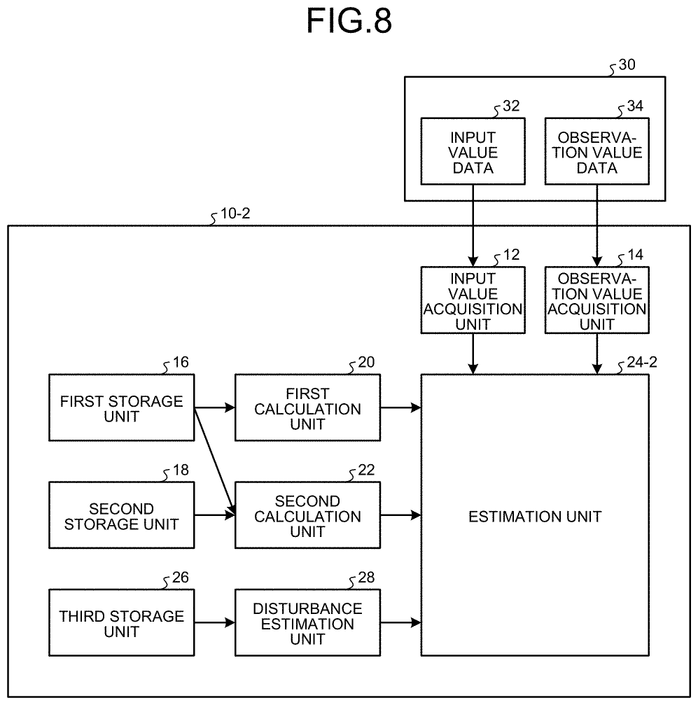

FIG. 8 is a diagram illustrating a functional configuration of a parameter identification device 10-2 according to a third embodiment of the present invention. The parameter identification device 10-2 is obtained by adding a third storage unit 26 and a disturbance estimation unit 28 to the parameter identification device 10 according to the first embodiment, and including an estimation unit 24-2 instead of the estimation unit 24. The parameter identification device 10-2 may have a configuration obtained by adding the third storage unit 26 and the disturbance estimation unit 28 to the parameter identification device 10-1 according to the second embodiment, and including the estimation unit 24-2 instead of the estimation unit 24.

The third storage unit 26 stores an unknown disturbance estimation model for generating an estimated disturbance quantity u_{d} on the basis of the extended state quantity z and the first-order differential value zdot of the extended state quantity. The unknown disturbance estimation model is expressed by the following formula (25).

[Formula 25]

u_{d}=d₀(z,zdot) (25)

In formula (25), u_{d} represents an estimated disturbance quantity, and dₒ represents a function related to the disturbance. The estimated disturbance quantity u_{d} at a certain time t is calculated on the basis of the extended state quantity z and the first-order differential value zdot of the extended state quantity z. For example, in a case where a frictional force and a torque of a drive unit of the target system are unknown disturbances, the unknown disturbances are described by position, velocity, acceleration, and the like.

With the use of the first storage unit 16 and the third storage unit 26, the disturbance estimation unit 28 calculates an estimated disturbance quantity u_{d,k} in the k-th step on the basis of the extended state quantity zₖ in the k-th step which is the first time step, and the input value uₖ. The disturbance estimation unit 28 then outputs the calculated estimated disturbance quantity u_{d,k}. A function of the disturbance estimation unit 28 is indicated by a modified disturbance model expressed by the following formula (26).

[Formula 26]

u_{d,k}=d(zₖ,uₖ) (26)

In formula (26), d is a function related to the disturbance after modification.

First, on the basis of the extended state quantity zₖ in the k-th step and the input value uₖ acquired from the input value acquisition unit 12, the disturbance estimation unit 28 calculates the first-order differential value zdotₖ of the extended state quantity zₖ in the k-th step, using the extended continuous equation of state expressed by formula (3) which is the first equation stored in the first storage unit 16. On the basis of the calculated first-order differential value zdotₖ and the extended state quantity in the k-th step, the disturbance estimation unit 28 calculates the estimated disturbance quantity u_{d,k} in the k-th step using the unknown disturbance estimation model stored in the third storage unit 26.

In a case of performing simultaneous estimation of a state quantity and a parameter to which a state estimation technique is applied while compensating for the influence of an unknown disturbance having acceleration dependency, a disturbance estimator using driver position information and a proportion integral (PI) compensator is considered. In that case, a problem resides in that second-order differentiation of the driver position information or an operation corresponding to the second-order differentiation is performed to deal with a high-frequency noise component. On the other hand, in the present embodiment, driver acceleration can be directly estimated, so that the problem can be solved.

The process of identifying the parameter θ by the parameter identification device 10-2 is similar to that in FIG. 4, and a difference therefrom resides in a detailed operation in step S105. In the prediction process in step S105, as expressed by the following formula (27), the estimation value zₖ\hat{ } of the extended state quantity and the input value uₖ in the step are substituted into formula (26) which expresses the modified disturbance model obtained from the disturbance estimation unit 28 to calculate the estimated disturbance quantity u_{d,k}\hat{ } in the step.

[Formula 27]

û_{d,k}=d(\hat{z}ₖ,uₖ) (27)

In a subsequent estimation process, uₖ is substituted with uₖ+u_{d,k}\hat{ }. As described above, according to the third embodiment of the present invention, it is possible to estimate the unknown disturbance with high accuracy, and to perform simultaneous estimation of the state quantity and the parameter to which the state estimation technique is applied while compensating for the influence of the unknown disturbance.

Subsequently, a hardware configuration of the parameter identification devices 10, 10-1, and 10-2 according to the first to third embodiments of the present invention will be described. Each of the functions of the parameter identification devices 10, 10-1, and 10-2 is realized by processing circuitry. The pieces of processing circuitry may be realized by dedicated hardware, or may be each a control circuit using a central processing unit (CPU).

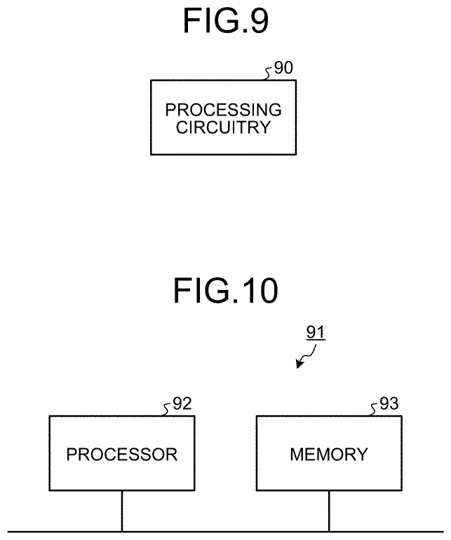

In a case where the above-described processing circuitry is realized by dedicated hardware, the processing circuitry is realized by a processing circuitry 90 illustrated in FIG. 9. FIG. 9 is a diagram illustrating dedicated hardware for realizing functions of the parameter identification devices 10, 10-1, and 10-2 according to the first to third embodiments of the present invention. The processing circuitry 90 is a single circuit, a composite circuit, a programmed processor, a parallel programmed processor, an application specific integrated circuit (ASIC), a field programmable gate array (FPGA), or a combination thereof.

In a case where the above-described processing circuitry is realized by a control circuit using a CPU, the control circuit is a control circuit 91 configured as illustrated in FIG. 10, for example. FIG. 10 is a diagram illustrating a configuration of the control circuit 91 for realizing the functions of the parameter identification devices 10, 10-1, and 10-2 according to the first to third embodiments of the present invention. As illustrated in FIG. 10, the control circuit 91 includes a processor 92 and a memory 93. The processor 92 is a CPU, and also referred to as a central processing device, a processing device, an arithmetic device, a microprocessor, a microcomputer, a digital signal processor (DSP), or the like. The memory 93 is, for example, a non-volatile or volatile semiconductor memory such as a random access memory (RAM), a read only memory (ROM), a flash memory, an erasable programmable ROM (EPROM), or an electrically EPROM (EEPROM (registered trademark)), a magnetic disk, a flexible disk, an optical disk, a compact disc, a mini disk, or a digital versatile disk (DVD).

In a case where the above-described processing circuitry is realized by the control circuit 91, the processing circuitry is realized by the processor 92 reading and executing a computer program corresponding to a process of each component stored in the memory 93. The memory 93 is also used as a temporary memory in each process executed by the processor 92. The computer program may be provided via a communication path or may be provided in a state of being recorded on a recording medium.

### Fourth Embodiment

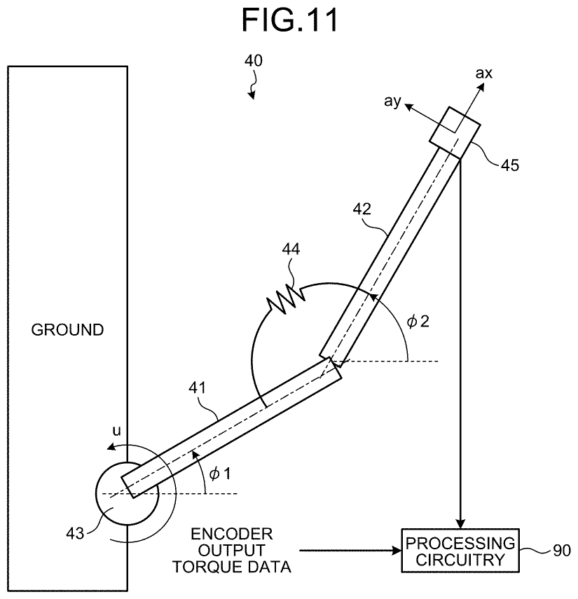

FIG. 11 is a diagram illustrating an example application of the parameter identification devices 10, 10-1, and 10-2 according to the first to third embodiments of the present invention.

A planar two-link robot 40 illustrated in FIG. 11 is an example of the target system. The parameter identification devices 10, 10-1, and 10-2 can identify a parameter of the planar two-link robot 40 illustrated in FIG. 11.

The planar two-link robot 40 includes a first link 41 and a second link 42. The first link 41 and the second link 42 are rigid links. The first link 41 is coupled by a joint which is rotatable relative to the ground and is driven by a rotary motor 43. The second link 42 is coupled to the first link 41 via a coupling unit 44. The coupling unit 44 includes a rotation spring that applies a rotational force and a rotation attenuator that applies a force in a direction that attenuates rotation.

An encoder which is an angle sensor is attached to the rotary motor 43, and a biaxial acceleration sensor 45 is attached to a distal end of the second link 42.

In a case where the parameter identification devices 10, 10-1, and 10-2 each identify a parameter of the planar two-link robot 40, the input value u to the target system is data of an applied torque of the rotary motor 43, and the observation value y of the target system is data from the encoder attached to the rotary motor 43, that is, a rotation angle φ1 of the first link 41, and data ax and ay output by the biaxial acceleration sensor 45. In that case, parameters to be estimated are a rigidity value K of the rotation spring of the coupling unit 44 and an attenuation value C of the rotation attenuator, and C is a vector including the combined value K and the attenuation value C as expressed by the following formula (28).

[Formula 28]

θ=(K,C)^{T} (28)

The continuous equation of state of the target system can be described in the form of formula (1) on the basis of an equation of motion thereof. In the present example, the state quantity x is a vector including the rotation angles φ1 and φ2 of the first link 41 and the second link 42 as expressed by the following formula (29).

[Formula 29]

x=(ϕ1,ϕ2)^{T} (29)

The extended state quantity of the target system is defined as x=(x,θ)^{T}, and the extended continuous equation of state can be described in the form of formula (3).

As expressed by the following formula (30), the observation value y is a vector including data from the encoder attached to the rotary motor 43, that is, the rotation angle φ1 of the first link and the data ax and ay output by the biaxial acceleration sensor 45.

[Formula 30]

y=(ϕ1,ax,ay)^{T} (30)

Then, the extended observation equation of the target system can be described in the form of formula (4) on the basis of the kinematics.

The first equation of the parameter identification device 10 according to the first embodiment of the present invention is the extended continuous equation of state expressed by formula (3), and the second equation thereof is the observation equation expressed by formula (4). The estimation unit 24 of the parameter identification device 10 estimates the extended state quantity z. As a result, the estimation unit 24 can estimate the state quantity x of the target system, that is, the rotation angle φ1 of the first link 41 and the rotation angle φ2 of the second link 42, and the parameter θ, that is, the rigidity value k of the rotation spring and the attenuation value C of the rotation attenuator.

The first equation of the parameter identification device 10-1 according to the second embodiment of the present invention is the continuous equation of state expressed by formula (1), and the second equation thereof is the observation equation expressed by formula (4). The estimation unit 24 of the parameter identification device 10-1 estimates the extended state quantity z.

The first equation of the parameter identification device 10-2 according to the third embodiment of the present invention is the extended continuous equation of state expressed by formula (3), and the second equation thereof is the observation equation expressed by formula (4). In the present embodiment, a friction torque of the rotary motor 43 is an unknown disturbance having acceleration dependency, and an estimation model as described in formula (25) is constructed. Consequently, the estimation unit 24-2 of the parameter identification device 10-2 estimates the extended state quantity z.

Although FIG. 11 illustrates the example in which the above process is performed inside the processing circuitry 90, the process may be performed by the control circuit 91.

Note that the target system is not limited to the planar two-link robot 40 illustrated in FIG. 11, and the present invention can be applied to a wide variety of general mechanical systems including a three-dimensional multi-rigid-body system. A parameter to be estimated may be a parameter related to mass, centroid position, moment of inertia, linear rigidity, attenuation, or the like, appearing in the equation of state. The input value u is not limited to the data of the applied torque of the rotary motor 43, and may be, for example, a driving thrust or the like in a case where the target system is a linear drive system. The sensor that acquires the observation value y may be a resolver or the like. Depending on the sensor used, the observation value y may be an angular velocity or an angular acceleration. In a case where the target system is a linear drive system, the sensor that acquires the observation value y may be a linear encoder, and a triaxial acceleration sensor may be used instead of the biaxial acceleration sensor 45.

In the above example, one encoder is attached to the rotary motor 43 and one biaxial acceleration sensor 45 is attached to the second link 42, but a plurality of encoders and a plurality of biaxial acceleration sensors 45 may be provided. Regarding input value data and output value data used for estimation, operation patterns are not limited, and a general positioning operation, an M-sequence/random signal operation, a periodic operation, or the like may be employed.

The configurations described in each embodiment above are merely examples of the content of the present invention and can be combined with other known technology and part thereof can be omitted or modified without departing from the gist of the present invention.

### REFERENCE SIGNS LIST

10, 10-1, 10-2 parameter identification device; 12 input value acquisition unit; 14 observation value acquisition unit; 16, 16-1 first storage unit; 18 second storage unit; 20, 20-1 first calculation unit; 22, 22-1 second calculation unit; 24, 24-2 estimation unit; 26 third storage unit; 28 disturbance estimation unit; 30 external storage medium; 32 input value data; 34 observation value data; 40 planar two-link robot; 41 first link; 42 second link; 43 rotary motor; 44 coupling unit; 45 biaxial acceleration sensor; 90 processing circuitry; 91 control circuit; 92 processor; 93 memory.

1. A parameter identification device that identifies a parameter of a target system, the device comprising:
a first storage to store a first equation that is a continuous equation, which expresses a first-order differential value of a first quantity including a state quantity of the system using an input value to the system and the first quantity;
a second storage to store a second equation, which expresses an output of the system using the first-order differential value and an extended state quantity that includes the state quantity and the parameter; and
processing circuitry
to perform a first calculation to calculate the extended state quantity in a second time step that is a next time step of a first time step, using the first equation, a first quantity in the first time step, and an input value to the system in the first time step;
to perform a second calculation to calculate an output of the system in the first time step, using the first equation, the second equation, the extended state quantity in the first time step, and the input value in the first time step; and
to estimate the extended state quantity, using an input value to the system acquired in each time step, an output value from the system acquired in each time step, the first calculation, and the second calculation.

2. The parameter identification device according to claim 1, wherein
the first quantity is the extended state quantity, and
the processing circuitry calculates the extended state quantity using a third equation obtained by performing numerical discretization of the first equation.

3. The parameter identification device according to claim 1, wherein
the parameter is time-invariant,
the first quantity is the state quantity, and
the processing circuitry calculates the state quantity in the second time step using the first equation and a predetermined numerical integration method, and calculates the extended state quantity in the second time step using the calculated state quantity and a fact that the parameter is time-invariant.

4. The parameter identification device according to claim 1, further comprising:
a third storage to store an unknown disturbance estimation model for generating an estimated disturbance quantity on a basis of the extended state quantity and a first-order differential value of the extended state quantity; and wherein
the processing circuitry outputs the estimated disturbance quantity on a basis of the extended state quantity and the input value in the first time step, using the first storage and the third storage, and
estimates the extended state quantity using the estimated disturbance quantity.

5. A parameter identification method for identifying a parameter of a target system by a parameter identification device, the method comprising:
acquiring an input value to the system in each time step;
acquiring an output value from the system in each time step;
calculating an extended state quantity using a first equation that is a continuous equation expressing a first-order differential value of a first quantity including a state quantity of the system by use of an input value to the system and the first quantity, using the first quantity in a first time step, and using an input value to the system in the first time step, the extended state quantity including the state quantity and the parameter in a second time step that is a next time step of the first time step;
calculating an output of the system in the first time step using the first equation, using a second equation that expresses an output of the system by use of the extended state quantity and the first-order differential value, using the extended state quantity in the first time step, and using the input value in the first time step; and
identifying the parameter by estimating the extended state quantity.

6. A non-transitory computer readable storage medium which stores a computer program for identifying a parameter of a target system, the computer program causing a computer to execute:
acquiring an input value to the system in each time step;
acquiring an output value from the system in each time step;
calculating an extended state quantity using a first equation that is a continuous equation that expresses a first-order differential value of a first quantity including a state quantity of the system by use of an input value to the system and the first quantity, using the first quantity in a first time step, and using an input value to the system in the first time step, the extended state quantity including the state quantity and the parameter in a second time step that is a next time step of the first time step;
calculating an output of the system in the first time step using the first equation, using a second equation that expresses an output of the system by use of the extended state quantity and the first-order differential value, using the extended state quantity in the first time step, and using the input value in the first time step; and
identifying the parameter by estimating the extended state quantity.

7. The parameter identification device according to claim 2, further comprising:
a third storage to store an unknown disturbance estimation model for generating an estimated disturbance quantity on a basis of the extended state quantity and a first-order differential value of the extended state quantity; and wherein
the processing circuitry outputs the estimated disturbance quantity on a basis of the extended state quantity and the input value in the first time step, using the first storage and the third storage, and
estimates the extended state quantity using the estimated disturbance quantity.

8. The parameter identification device according to claim 3, further comprising:
a third storage to store an unknown disturbance estimation model for generating an estimated disturbance quantity on a basis of the extended state quantity and a first-order differential value of the extended state quantity; and wherein
the processing circuitry outputs the estimated disturbance quantity on a basis of the extended state quantity and the input value in the first time step, using the first storage and the third storage, and
estimates the extended state quantity using the estimated disturbance quantity.
